(19) United States
(12) Patent Application Publication
(10) Pub. No.: US 2014/0006299 A1
(43) Pub. Date: Jan. 2, 2014

(54) CONNECTING CANDIDATES AND EMPLOYERS USING CONCISE MESSAGING

(71) Applicant: RECRUITER CANDIDATE CONNECTION, LLC, St. Louis, MO (US)

(72) Inventors: Drew Acree, St. Louis, MO (US); Jeff Kelley, Alton, IL (US); Rob Barrett, St. Charles, MO (US)

(73) Assignee: Recruiter Candidate Connection, LLC, St. Louis, MO (US)

(21) Appl. No.: 13/835,417

(22) Filed: Mar. 15, 2013

Related U.S. Application Data
(60) Provisional application No. 61/667,132, filed on Jul. 2, 2012.

(51) Int. Cl. G06Q 10/10

(52) U.S. Cl. CPC G06Q 10/1053
USPC 705/321

(57) ABSTRACT

Methods and systems for matching employers and candidates. One method includes receiving a first plurality of job descriptions from a first user associated with a first unique username, and transmitting the first plurality of job descriptions and the first unique username to a server. The method also includes receiving an employment match based on the first plurality of job descriptions and the unique username from the server, wherein the employment match includes a second plurality of job descriptions specified by a second user, a second unique username associated with the second user, and contact information for the second user. In addition, the method includes displaying the employment match to the first user, receiving a text message from the first user, and transmitting the text message to the second user based on the contact information included in the employment match.

### RELATED APPLICATIONS

The present application claims priority to U.S. Provisional Application No. 61/667,132, filed Jul. 2, 2012, the entire contents of which are hereby incorporated by reference.

### FIELD

Embodiments of the present invention relate to systems and methods for providing a simple way for job-seeking candidates and candidate-seeking employers to find each other and communicate with each other quickly and efficiently.

### BACKGROUND

Current systems and methods for matching job candidates and employers are inefficient. For example, many current systems and methods lack employer accountability and do not hold employers accountable for each position they post. On a regular basis, a candidate may show an interest in a job but never receive any feedback from the employer. While the employer may have simply chosen not to respond, the candidate does not know whether an actual person read their application or if a non-human system filtered out their application. This uncertainty occurs because the candidate does not know and, subsequently, cannot contact, the person responsible for analyzing applications. Therefore, employers are not held accountable when they post a job to an ordinary job board. Furthermore, it is time consuming for candidates to read lengthy job descriptions, and it is time consuming for employers to read and analyze lengthy resumes and cover letters.

### SUMMARY

Accordingly, embodiments of the invention provide methods and systems for providing a simple way for candidates and employers to find each other and directly communicate with each other quickly and efficiently. In some embodiments, these methods and systems are used to match candidates and employers performing contract work for the federal government.

In some embodiments, candidates and employers each use a mobile application installed on a smart phone, tablet, or other electronic device with a processor, memory, and an input/output interface that allows candidates and employers to enter job descriptions (e.g., a clearance level, a location, a title, etc.) and view employment matches. In particular, the application displays brief, concise information for each employment match. In some embodiments, each employment match also includes contact information for directly contacting the employer or candidate. Therefore, when a candidate or employer finds an employment match of interest, the candidate or employer can use the application to directly communicate with the other party, such as by sending an email message or a text-based message. The messages can be limited to a predetermined number of characters (e.g., approximately 140 to 200 characters) and, in some embodiments, are self-contained within the application as to not clutter general email accounts or text-message accounts. Thus, communication between candidates and employers occurs quickly, easily, and efficiently.

In other embodiments, candidates and employers use a browser application to access a website that manages employment matches between candidates and employers. The website prompts candidates seeking employment for job descriptions, such as a security clearance and a geographical location or region where the candidate is seeking employment. The website also prompts employers seeking candidates for job descriptions, such as a security clearance of the job opening, a geographical location or region of the job opening, and a job title. After collecting the information from candidates and the information from employers, the website displays employment matches for both candidates and employers. For example, a candidate or employer can log into the website to access their respective employment matches. In some embodiments, the website displays employment matches in a “Twitter-like” feed that provides a concise and brief description of each match. For example, each matching job opening displayed to a candidate can include a job description that is limited to approximately 140 to 200 characters. In some embodiments, actual Twitter feeds can be used to provide employment matches to candidates and employers.

Additionally, in some embodiments, one or both of the candidate and the employer are identifiable by a unique username (e.g., selected by the candidate or employer or automatically assigned). The usernames can be exchanged between matching candidates and employers in place of providing other identifying information. Accordingly, because an employer does not obtain a name or other identifying information regarding a candidate, it is difficult for an employer to illegally discriminate against a candidate. Furthermore, once a username is established by an employer (as part of a registration process), the employer can post new jobs at any time, which are made available to matching candidates within seconds or minutes. Similarly, once a username is established by a candidate (as part of a registration process), the candidate can update the job description of their desired job at any time, which are made available to matching employers within seconds or minutes.

In particular, one embodiment of the invention provides a method of matching employers and candidates. The method includes receiving a first plurality of job descriptions from a first user associated with a first unique username, and transmitting the first plurality of job descriptions and the first unique username to a server. The method also includes receiving an employment match based on the first plurality of job descriptions and the unique username from the server, wherein the employment match includes a second plurality of job descriptions specified by a second user, a second unique username associated with the second user, and contact information for the second user. In addition, the method includes displaying the employment match to the first user, receiving a text message from the first user, and transmitting the text message to the second user based on the contact information included in the employment match.

Another embodiment of the invention provides a system for matching employers and candidates. The system includes at least one processor. The at least one processor is configured to receive a plurality of candidate profiles from a plurality of candidates, wherein each of the plurality of candidate profiles including a unique username associated with one of the plurality of candidates and a plurality of job descriptions and receive a plurality of employer profiles from a plurality of employers, wherein each of the plurality of employer profiles including a unique username associated with one of the plurality of employers and a plurality of job descriptions. The at least one processor is also configured to determine a match between one of the plurality of candidates and one of the plurality of employers based on a degree of similarity between the plurality of job descriptions included in each of the plurality of candidate profiles and the plurality of job descriptions included in each of the plurality of employer profiles. Furthermore, the at least one processor is configured to provide information regarding the match to the one of the plurality of employers, wherein the information includes the unique username associated with the one of the plurality of candidates and no other identifying information of the one of the plurality of candidates. In some embodiments, the at least one processor is further configured to provide second information regarding the match to the one of the plurality of candidates, wherein the second information includes the unique username associated with the one of the plurality of employers and no other identifying information of the one of the plurality of employers.

Other aspects of the invention will become apparent by consideration of the detailed description and accompanying drawings.

### BRIEF DESCRIPTION OF THE DRAWINGS

FIG. 1 schematically illustrates a system for matching a candidate and an employer.

FIG. 2 schematically illustrates the system of FIG. 1 used by multiple candidates and multiple employers.

FIG. 3 is a flow chart illustrating a method of matching employers and candidates performed by the system of FIG. 1.

FIG. 4 is a screen shot illustrating a home page generated by the system of FIG. 1.

FIG. 5 is a flow chart illustrating a method of generating a profile performed by the system of FIG. 1.

FIGS. 6 and 7 are screen shots illustrating template pages generated by the system of FIG. 1.

FIG. 8 is a screen shot illustrating an access-matches page generated by the system of FIG. 1.

FIG. 9 is a flow chart illustrating a method of completing a connection performed by the system of FIG. 1

FIG. 10 is a screen shot illustrating a complete-connection page generated by the system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. Also, electronic communications and notifications may be performed using any known means including direct connections, wireless connections, etc. It should also be noted that a plurality of hardware- and software-based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

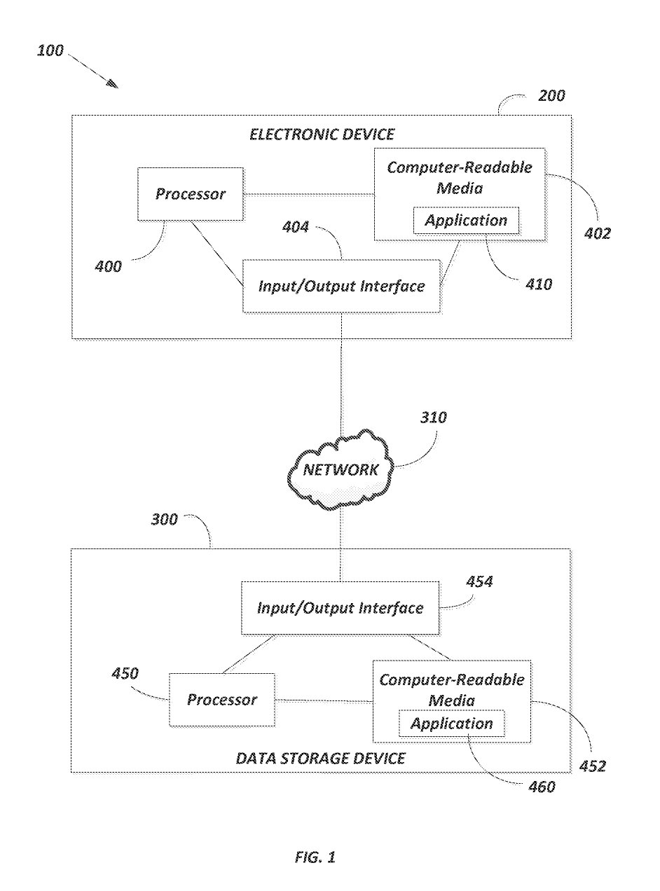

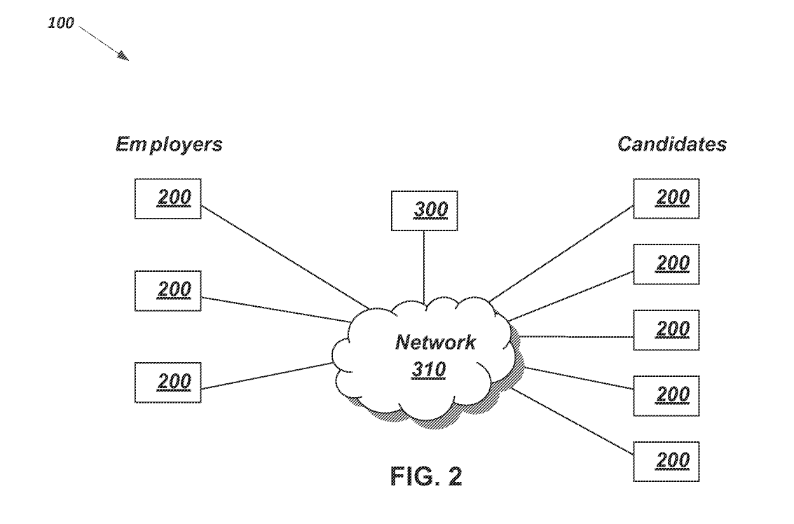

FIG. 1 illustrates a system 100 for matching a candidate and an employer. It should be understood that as used in the present application the term “employer” includes third-party recruiters that recruit on behalf of an employer. As illustrated in FIG. 1, the system 100 includes an electronic device 200 operated by a candidate or an employer that communicates with a data storage device 300 over a network 310. The network 310 can include the Internet, a telephone network (e.g., a cellular network), a wide-area-network (“WAN”), a local-area-network (“LAN”), or combinations thereof. The network 310 can be constructed from one or more wired and/or wireless connections. It should he understood that multiple candidates and multiple employers can use an electronic device 200 to communicate with the data storage device 300 over the network 310 (see, e.g., FIG. 2). Also, an electronic device 200 operated by a particular candidate may differ from other candidates or other employers. For example, a candidate may use an electronic device 200 that includes a smart phone, and an employer may use an electronic device 200 that includes a laptop or desktop computer.

The electronic device 200 can include a smart phone, a tablet computer, a laptop computer, a desktop computer, or a similar device capable of communicating over the network 310 with other devices including the data storage device 300. As illustrated in FIG. 1, the electronic device 200 includes a processor 400 (e.g., a microprocessor), non-transitory computer-readable media 402, and an input/output interface 404. It should be understood that, in other constructions, the electronic device 200 includes additional, fewer, or different components.

The processor 400 is configured to retrieve instructions and data from the media 402 and execute, among other things, the instructions to collect information from a candidate or an employer, transmit the collected information to the data storage device 300, receive information from the data storage device 300, and display the received information to a candidate or employer. The input/output interface 404 exchanges data between the device 200 and external systems, networks, and/or devices. In particular, the input/output interface 404 communicates with the data storage device 300 over the network 310. The input/output interface 404 can store data received from external sources to the media 402 and/or provide the data to the processor 400.

The computer-readable media 402 stores program instructions and data including an application 410 for collecting information from a candidate or an employer and displaying employment matches to a candidate or employer. In some embodiments, the application 410 is a mobile application a smart phone application) specifically programmed to collect information, display employment matches, and allow a candidate or employer to communicate with an employment match. The application 410 is configured to communicate with the data storage device 300 to provide a profile and retrieve employment matches based on the profile.

In other embodiments, the application 410 includes a browser application (e.g., Microsoft Internet Explorer®, Moxilla Firefox®, Google Chrome®, etc.) that allows a candidate or an employer to access data stored in the data storage device 300 through a website hosted by the data storage device 300 or a separate server. As described above in the summary section, the website collects information from candidates and employers and displays employment matches to each within the website. As described in more detail below, the employment matches can be provided as a feed of short, concise job descriptions or candidate qualifications (e.g., approximately 140 to 200 characters) to increase efficiency.

The data storage device 300 receives and stores information from electronic devices 200 regarding candidates and employers, matches information between candidates and employers to identify employment matches for both candidates and employers, and transmits employment matches to electronic devices 200. As illustrated in FIG. 1, the data storage device 300 can include a server that includes a processor 450 (e.g., a microprocessor), non-transitory computer-readable media 452 (e.g., at least one database), and an input/output interface 454. It should be understood that in other constructions, the data storage device 300 includes additional, fewer, or different components.

The processor 450 is configured to retrieve instructions and data from the media 452 and execute, among other things, the instructions to receive information from candidates and employers, determine employment matches for candidates and employers based on the received information, and provide the matches to candidates and employers. The input/output interface 454 exchanges data between the data storage device 300 and external systems, networks, and/or devices. In particular, the input/output interface 454 communicates with the electronic devices 200 over the network 310. The input/output interface 454 can also store data received from external sources to the media 452 and/or provide the data to the processor 450.

The computer-readable media 452 stores program instructions and data for matching candidates and employers. In particular, the media 452 stores information obtained from the electronic devices 200 (e.g., from a candidate or an employer) and stores an application 460 for generating employment matches for both candidates and employers. In some embodiments, the application 460 includes a website accessible by a browser application executed by an electronic device 200. In other embodiments, alternatively or in addition, the application 460 processes and provides data to a mobile application executed by an electronic device 200. Data used by the application 460 (e.g., to populate a website or provide data to a mobile application) can also be stored in the media 452. However, it should be understood that the application 460 and the data used by the application 460 can be stored on separate data storage devices (e.g., separate servers).

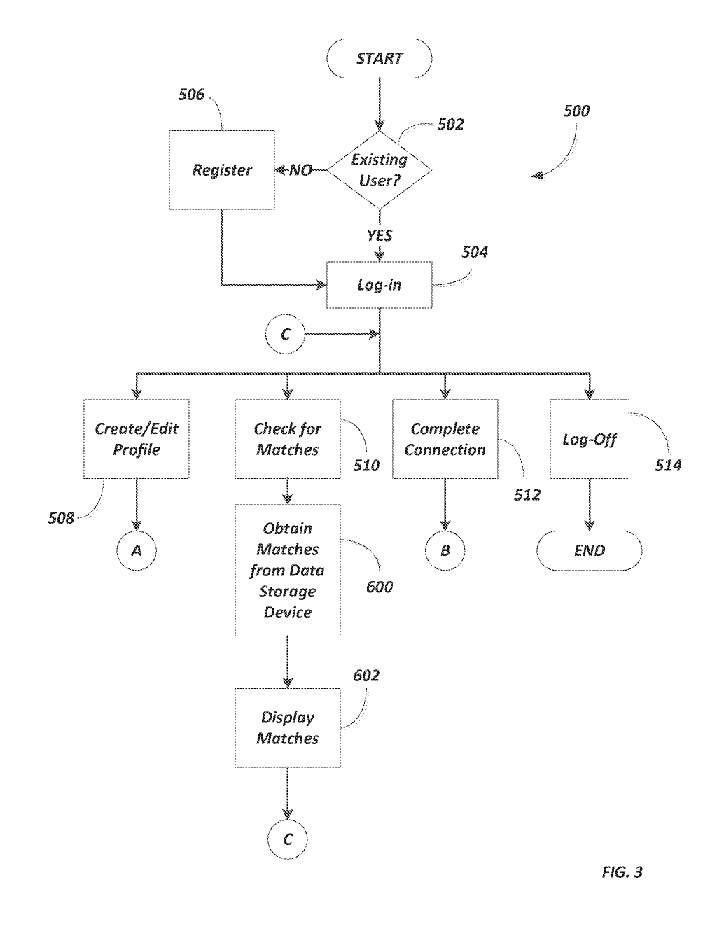

FIG. 3 is a flow chart illustrating a method 500 of matching employers and candidates performed by the system 100. It should be understood that the functionality described below with reference to the method 500 can be performed by the electronic device 200 (i.e., the application 410 as executed by the processor 400) or the data storage device (i.e., the application 460 as executed by the processor 450). In particular, the functionality of the system 100 can be distributed between the devices 200 and 300 in various configurations.

As illustrated in FIG. 3, the electronic device 200 (using the mobile application or a browser application) initially displays a screen to a candidate or an employer that allows the candidate or the employer to log-in (at 502). For example, a candidate or an employer (hereinafter referred to interchangeably as a “user”) can provide a username and a password to log-in (at 504).

Alternatively, if the user has not previously registered with the system 10, the user can register (at 506). To register with the system 100, the device 200 prompts the user for a unique username and a password. In some embodiments, the device 200 or the data storage device 300 is configured to automatically generate a unique username and/or password for the user, but the user may be given the opportunity to change either the username or the password. The device 200 can also prompt the user to identity whether he or she is a candidate seeking employment or an employer seeking position fulfillment. The device 200 also prompts the user for contact information, such as a home address, a telephone number, or an email address. If a user is registering as an employer, the device 200 can also prompt the employer for a government certification code (e.g., a CAGE code) that verifies that the employer is a valid contractor for the federal government.

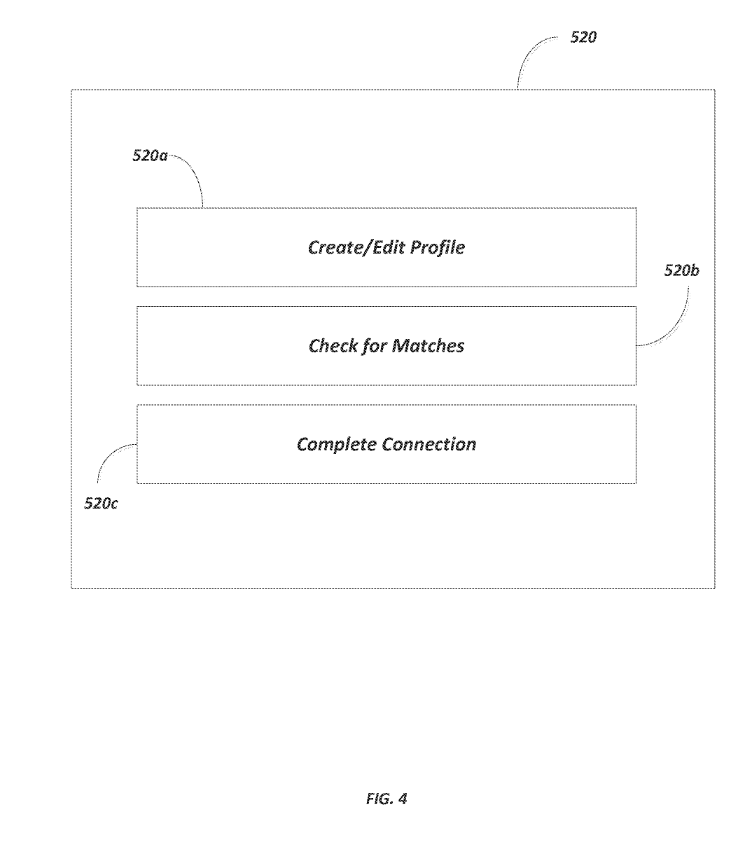

After registering and logging in (which may occur automatically during the registration process) or logging in as a previously-registered user (at 506), the user can use the device 200 to create or edit a profile (at 508), check for employment matches (at 510), complete a connection (at 512), or log-off (at 514). For example, as illustrated in FIG. 4, the device 200 can display a home or start page 520 after a user logs in. The start page 520 includes a create/edit-profile selection mechanism 520a, a check-for-matches selection mechanism 520b, and a complete-connection selection mechanism 520c.

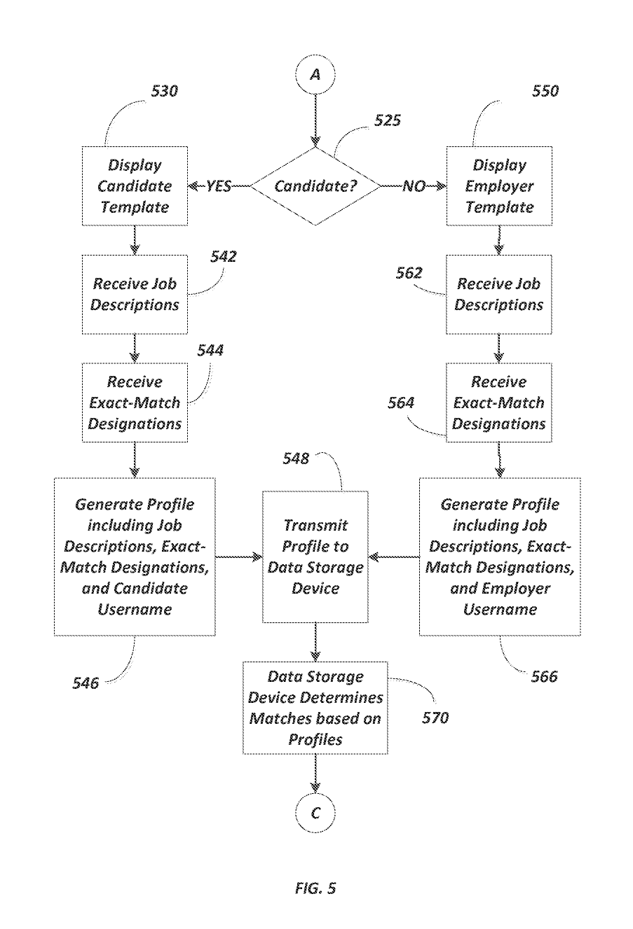

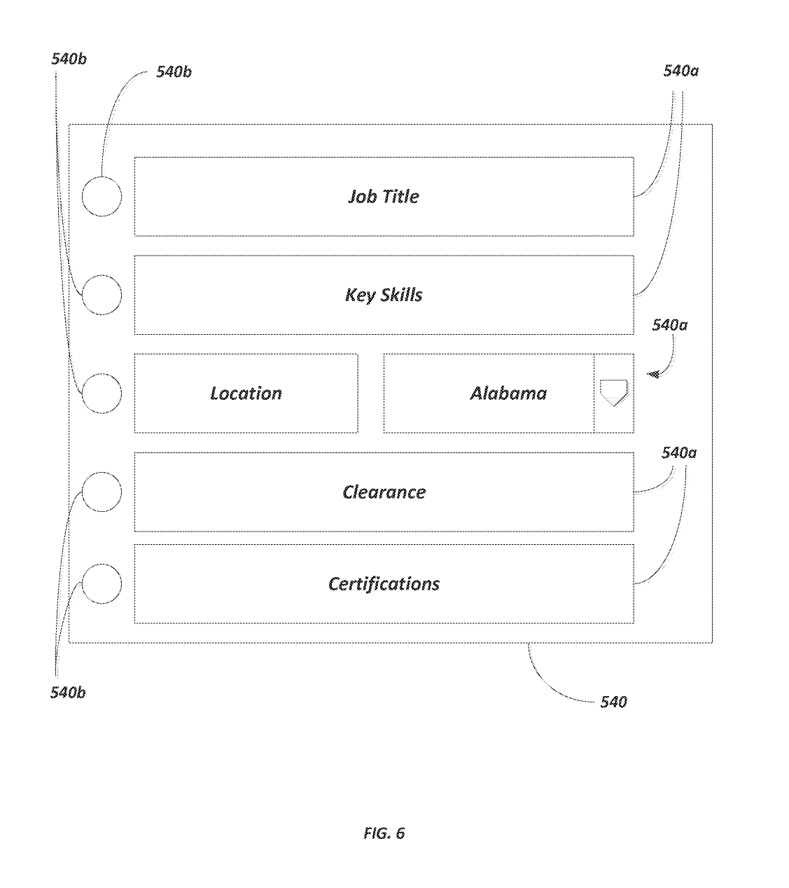

If a candidate selects (e.g., by clicking, touching with a finger or a stylus, etc.) (at 525, FIG. 5), the create/edit-profile selection mechanism 520a, the device 200 displays a candidate template (at 530). FIG. 6 illustrates a candidate template 540 according to one embodiment of the invention. The candidate template 540 can include a plurality of input mechanisms 540a for receiving a plurality of job descriptions, such as job title, key skills, location, clearance, certifications, pay range, etc., from the candidate (at 542). The input mechanisms 540a can accept text from a user. Alternatively or in addition, some or all of the input mechanisms 540a can provide a menu (e.g., a drop-down menu) that allows a candidate to select value for a job description from a list of predefined values. For example, as illustrated in FIG. 6, an input mechanism 540a associated with a location can include a drop-down menu that lists available geographic locations (e.g., states). Similarly, an input mechanism 540a associated with a clearance level can provide a drop-down menu of available clearance levels. In some embodiments, character limits are applied to the plurality of job descriptions (e.g., individually or in total). For example, in some embodiments, the total number of characters included the plurality of job description is limited to approximately 140 characters to approximately 200 characters. As described below in more detail, the character restrictions are used to maintain short and concise information exchanged between candidates and employers.

In some embodiments, an exact-match selection mechanism 540b is associated with one or more of the input mechanisms 540a. A candidate can select (e.g., by clicking, touching with a finger or a stylus, etc.) an exact-match selection mechanism 540b associated with a particular input mechanism 540a to indicate whether the candidate requires an exact match for the job description associated with the input mechanism 540a (at 544). For example, if a candidate only wants to see job offerings exactly matching the location specified by the candidate, the candidate can select the exact-match selection mechanism 540b associated with the input mechanism 540a prompting the candidate for a location. If a candidate does not select or otherwise “turn-on” an exact-match selection mechanism 540h associated with a particular input mechanism 540a, the candidate indicates that he or she does not require an exact match for the job description associated with the input mechanism 540a.

The device 200 generates a candidate profile that includes the descriptions, the designations (if applicable), and the unique username associated with the candidate (at 546). After generating the candidate profile, the device 200 submits the profile to the data storage device 300 (at 548). Accordingly, as noted above, the candidate template 540 and the candidate profile generated based on data collected through the template 540, is short and concise, which limits the amount of information an employer must analyze before deciding whether to contact a candidate (e.g., for an interview). In particular, in some embodiments, resume information is not (and cannot be) uploaded to, stored, or used in the system 100. Rather, the system 100 exists as a brokering service that connects candidates and employers. In particular, as described in more detail below, within the system 100, job descriptions entered by employers are only made available to candidates providing matching job descriptions.

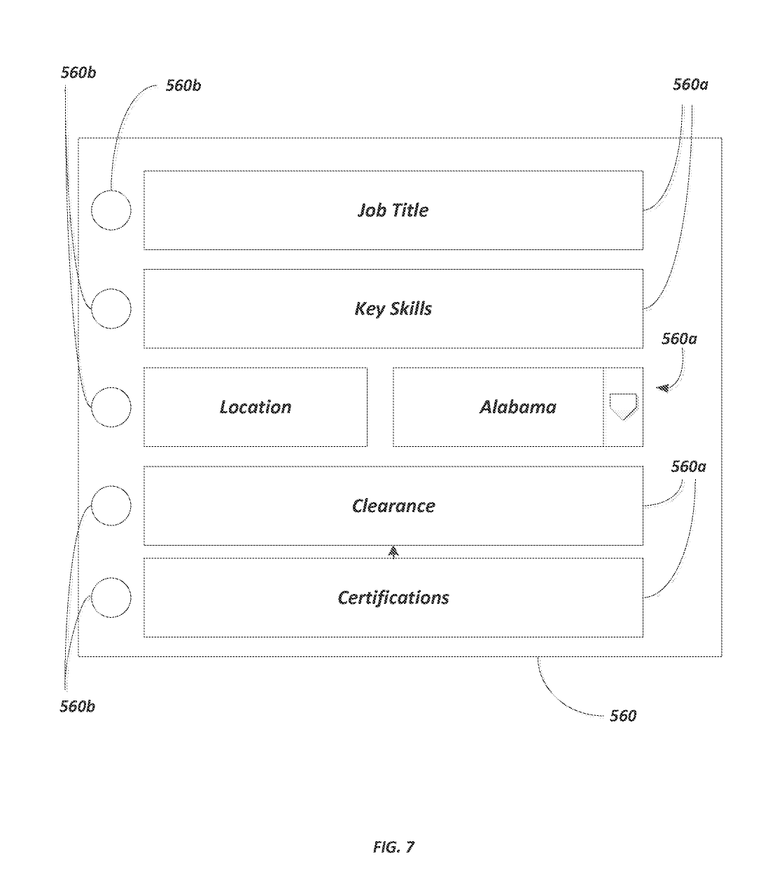

Returning to FIG. 3, if an employer selects (e.g., by clicking, selecting with a finger or stylus, etc) the create/edit-profile selection mechanism 520a, the device 200 displays an employer template (at 550). FIG. 7 illustrates an employer template 560 according to one embodiment of the invention. Similar to the candidate template 540, the employer template 560 includes a plurality of input mechanisms 560a for receiving a plurality of job descriptions (at 562) and one or more exact-match selection mechanisms 560b for receiving exact-match designations (at 564). As illustrated in FIG. 7, in some embodiments, the employer template 560 requests the same job descriptions as the candidate template 540. In other embodiments, the employer template 560 requests at least one job description different than the candidate template 540. As noted above with respect to the candidate template 540, in some embodiments, the plurality of job descriptions requested in the employer template 560 are character-limited (e.g., individually or in total) to maintain short and concise information exchanged between candidates and employers.

The device 200 generates an employer profile that includes the descriptions and exact-match designations received through the employer template 560 and the unique username associated with the employer (at 566). After generating the employer profile, the device 200 submits the profile to the data storage device 300 (at 548). Accordingly, the employer template 560 and the employer profile generated based on data input into the template 560, is concise to limit the amount of information a candidate must analyze before deciding whether to contact the employer. As noted above, in some embodiments, resume information is not (and cannot be) uploaded, stored, or used in the system 100. Rather, the system 100 exists as a brokering service that connects candidates and employers.

The data storage device 300 receives a plurality of candidate profiles from a plurality of candidates and a plurality of employer profiles from a plurality of employers. The device 300 stores the profiles (e.g., in a database) and determines one or more employment matches based on the profiles (at 570). Each employment match is between one of the plurality of candidates and one of the plurality of employers. In particular, in sonic embodiments, the data storage device 300 determine a degree of similarity between one or more of the job descriptions included in each candidate profile and one or more of the corresponding job descriptions included in each employer profile (e.g., similar job titles (“computer programmer” and “software programmer”), close geographic locations (e.g., Wisconsin and Illinois), pay ranges within $5,000 to $10,000, etc.). If a profile includes a job description that is associated with an exact-match designation, the device 300 automatically eliminates any profiles that do not include an exact match to the job description.

Therefore, the data storage device 300 provides candidates with a list of job descriptions specified by employers that “match” the candidate's specified job descriptions. In particular, a. candidate who enters a particular clearance level, location, and pay range is provided access to job postings entered by employers with similar or exactly-matching (e.g., depending on the designations specified by the candidate) clearance levels, geographic locations or regions, and pay ranges. Similarly, the data storage device 300 provides employers with a list of job descriptions specified by candidates that “match” the employer's specified job descriptions. In particular, an employer who posts a job opening for a particular clearance level, location, and pay range is provided access to information entered by candidates with similar or exactly-matching (e.g., depending on the designations specified by the employer) clearance levels, geographic locations or regions, and pay ranges.

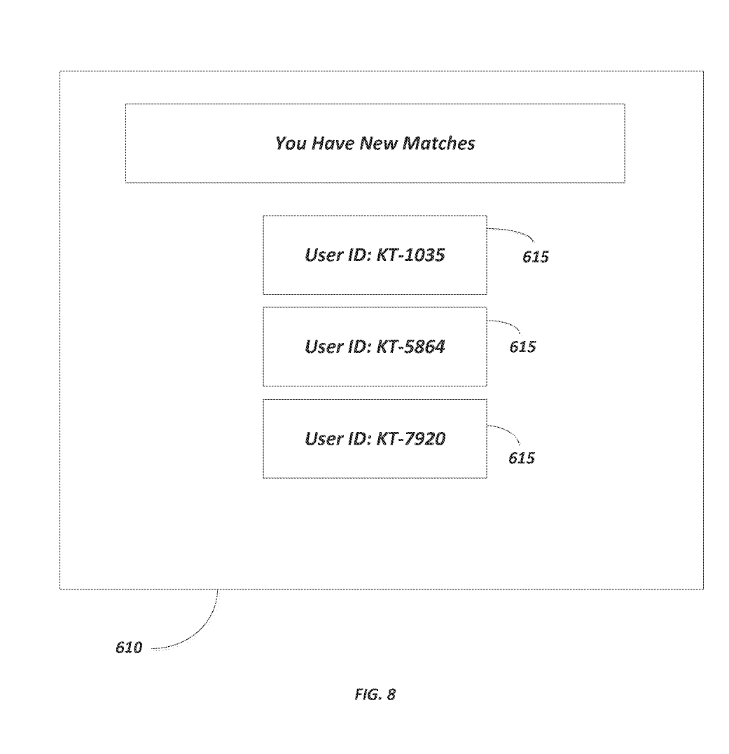

The device 300 stores identified matches (e.g., to a database) and provides identified matches to users. For example, as illustrated in FIG. 3, a user can use the application 410 executed by an electronic device 200 to check for and access employment matches determined by the device 300 (at 510). In particular, a user can select the check-for-matches selection mechanism 520b from the start page 520 illustrated in FIG. 4 to access and view employment matches. If a user selects the check-for-matches selection mechanism 520b, the device 200 obtains employment matches from the data storage device 300 (if the device 200 hasn't previously obtained the matches from the device 300) (at 600, FIG, 3). The device 200 displays the matches to the user (at 602). For example, FIG. 8 illustrates an example access-matches page 610 generated by the device 200. The access-matches page 610 displays the employment matches 615 determined by the device 300 for a particular user.

For a candidate, each displayed match 615 identifies the employer associated with the match 615 by the employer's unique username associated with the system 100 and, in some embodiments, does not provide any further identifying information regarding the employer. Similarly, each displayed match 615 for an employer identifies the candidate associated with the match 615 by the candidate's unique username associated with system 100, and in some embodiments, does not provide any further identifying information regarding the candidate. Accordingly, the system 100 can use the unique usernames to connect candidates and employers, which provides anonymity and prevents employers from unfairly discriminating against any candidates based on their name or other identifying information.

In some embodiments, a user can select a listed match 615 to view the job descriptions associated with the selected match 615. As noted above, the job descriptions can be character-limited (e.g., limiting the total characters to between approximately 140 and approximately 200 characters), which allows the information regarding a match 615 to provide in a short and concise format that can be quickly and efficient assessed by the user.

Also, in some embodiments, each match 615 includes contact information for contacting a matching party. For example, each match 615 identified by the data storage device 300 for a candidate can include contact information that allows the candidate to directly contact the employer responsible for the matching job posting. The contact information can include an email address (e.g., as a hyperlink), phone number (for sending text-messages), a username, or other information for contacting the employer. Similarly, each match 615 for an employer can also include contact information that allows the employer to directly contact the matching candidate. The contact information can include an email address (e.g., as a hyperlink), phone number (for sending text-messages), a username, or other information for contacting the candidate.

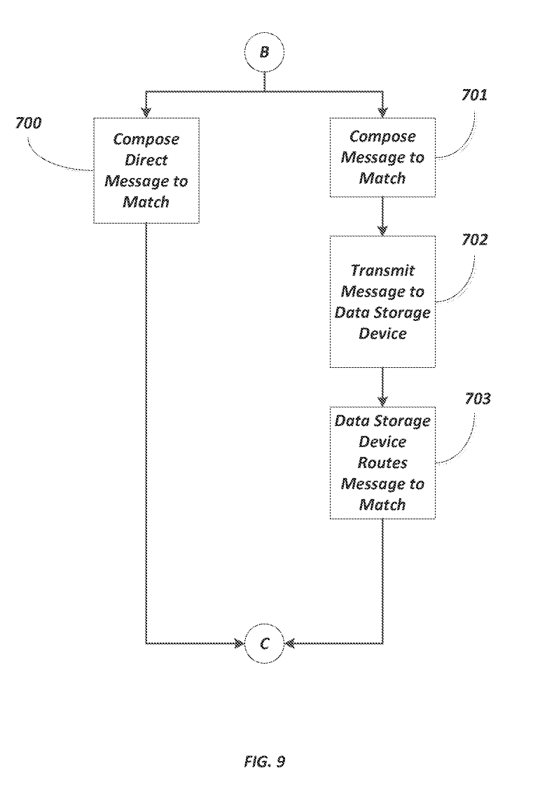

In particular, returning to FIG. 3, a user can select a complete-connection selection mechanism 520c from the start page 520 (or a selection mechanism associated with a match 615 displayed on the access-matches page 610), to complete a connection with a user associated with a selected match 615 (i.e., a “matching user”) (at 512). For example, as noted above, in some embodiments, a match 615 includes contact information, such as an email address or a telephone number, for the matching user. Accordingly, a user can use the contact information to directly contact a matching party (at 700, FIG. 9), such as by composing and transmitting an email message to an email address included in a match 615 or by composing and transmitting a text message to a telephone number included in a match 615. In some embodiments, the size of the message is limited (e.g., to approximately 140 to 200 characters) to keep communication between the parties concise and efficient. As used in the above sentence, “directly” contacting a matching party implies contacting the matching party without routing a message through the data storage device 300. Therefore, it should be understood that even a “direct” message may be routed through one or more intermediary devices (e.g., email servers, switches, routers, etc.) before reaching the matching user.

Accordingly, in these embodiments, candidates can contact an employer directly and, consequently, can expect to receive a response back from the employer. As noted above, the size of the direct messages can be limited. Accordingly, the communication can occur quickly and efficiently given the small message size. Therefore, the size limit and ability to directly contact a matching user saves time for both parties by allowing each party to gauge interest in each other and pursue further communication only if it is mutually beneficial.

Similarly, because each job posting is created by an employer with a valid username, which is provided in employment matches along with direct contact information, each employer is held accountable for each job they post. This accountability adds value for candidates because candidates are able to directly contact the employer who posted a job posting. Accordingly, candidates can expect that employers who use the system 100 desire to be directly contacted by a candidate identified as a match by the data storage device 300.

In other embodiments, a user can complete a connection by composing a message (at 701) that is routed to the data storage device 300 (at 702). The data storage device 300 then forwards or routes the message to the matching candidate or employer (at 703). Accordingly, in these embodiments, candidates and employers are allowed to communicate without requiring either party providing the other party with direct contact information, such as an email address or a telephone number.

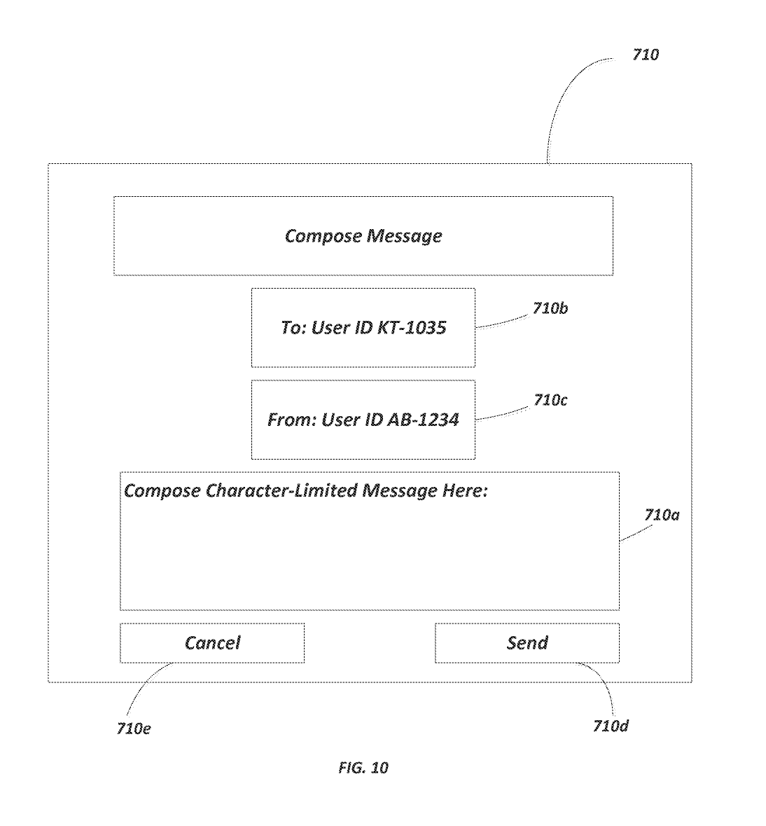

In some embodiments, regardless of how a user complete a connection, when a user selects the complete-connection selection mechanism 520c from the home page 520 (or a selection mechanism included in an employment match 615 to connect with the matching user), the device 200 displays a compose-message page 710 as illustrated in FIG. 10. As illustrated in FIG. 10, a user uses the compose-message page 710 to compose a message to the matching party within a text box 710a. In some embodiments, the text box 710a limits the number of characters that can be entered (e.g., between approximately 140 characters and approximately 200 characters), which, as noted above, keeps communication between candidates and employers concise and efficient. The device 200 can also be configured to automatically populate the “To:” field 710b and/or the “From:” field 710c based on the information included in the employment match 615 associated with the message (e.g., a username, email address, or telephone number) and the username of the user composing the message. After the user composes the message, the user can select a send selection mechanism 710d to send the message or can select a cancel selection mechanism 710e to cancel sending the message. As noted above, in some embodiments, the electronic device 200 automatically transmits the message to the matching user (e.g., based on direct contact information included in the employment match 615). In other embodiments, the device 200 forwards the message to the data storage device 300, and the data storage device 300 forwards the message to the matching user.

In some embodiments, regardless of whether the device 200 transmits a message directly to a matching user or transmits a message to the data storage device 300 for delivery, the message can he sent through and managed by the application 410 executed by the electronic device 200. In addition, if the electronic device 200 directly transmits messages to a matching user, responses to the message by the matching party are also received by and managed through the application 410. Therefore, communication between candidates and employers can be managed and retained within the application 410 rather than being managed through a general email or text-message account, where messages can be easily overlooked or lost.

As previously noted, the system and methods described herein may be particularly beneficial for employers and candidates within the federal government due to the standards enforced on government employers and contractors. For example, many federal government jobs require candidates to possess certain clearance levels and certifications and may also require background checks upon being hired. Therefore, a limited amount of information that contains these requirements is all that is needed for employers to determine if a candidate is qualified for an interview. Resume information may be considered extraneous and may be less beneficial to the employer than the specific clearance levels and certifications of a candidate, which can often be easily verified. Therefore, as noted above, in some embodiments, the system 100 does not and, in some embodiments, cannot use resume information.

It should be understood that instead of using a mobile application or a browser application to implement the above methods and systems, alternative embodiments are possible. in one such alternative embodiment, communication between candidates and employers may be facilitated through the use of a social networking environment, such as Twitter, Facebook, or LinkedIn. For example, in some embodiments, when a candidate provides information (e.g., using a candidate template displayed within the social networking website, at a separate website, or on the mobile application), the candidate agrees to subscribe to a Twitter feed or subscribe to or “like” a Facebook page that includes employment matches based on the candidate's provided information. Similarly, when an employer provides information (e.g., using an employer template displayed within the social networking website, a separate website, or on the mobile application), the employer agrees to subscribe to a Twitter feed or subscribe to or “like” a Facebook page that includes employment matches based on the employer's provided information. The page or feed can be associated with profiles having a predefined format. For example, a feed or profile page can exist for all candidate profiles having the title similar to “programming,” a clearance level of 4, certifications of “C++” and a location of “Wisconsin.” Therefore, if an employer submits a profile matching this format, the employer is subscribed to a feed or profile page that lists candidate profiles also matching this format. Similarly, a feed or profile page can exist for all employer profiles matching this format that is subscribed to by candidates providing a profile also matching the format.

In some embodiments, each feed or page can include contact information for a matching party (e.g., an email address, profile page reference, Twitter handle, etc) that allows a user to connect a matching party either through or outside of the social networking environment. In some embodiments, if the length of messages and job descriptions is not limited by the social networking environment, the system 100 limits these lengths as described above.

Therefore, embodiments of the invention provide systems and methods for providing a simple way for candidates and employers to find each other and communicate with each other in a fast and efficient manner.

Various features and advantages of the invention are set forth in the following claims.

What is claimed is:

1. A method of matching employers and candidates, the method comprising:
receiving, at a processor, a first plurality of job descriptions from a first user associated with a first unique username;
transmitting, by the processor, the first plurality of job descriptions and the first unique username to a server;
receiving, at the processor, an employment match based on the first plurality of job descriptions from the server, the employment match including a second plurality of job descriptions specified by a second user and contact information for the second user;
displaying, by the processor, the employment match to the first user;
receiving, at the processor, a text message from the first user; and
transmitting, by the processor, the text message to the second user based on the contact information included in the employment match.

2. The method of claim 1, further comprising:
receiving, at the server, the first plurality of job descriptions and the first unique username from the first processor,
receiving, at the server, the second plurality of job descriptions, a second unique username associated with the second user, and the contact information for the second user from a second processor,
determining, by the server, a match between the first user and the second user by identifying a degree of similarity between the first plurality of job descriptions and the second plurality of job descriptions,
generating, by the server, the first employment match for the first user,
transmitting, by the server, the first employment match to the first processor,
generating, by the server, a second employment match for the second user, the second employment match including the first plurality of job descriptions and contact information for the first user, and
transmitting, by the server, the second employment match to the second user.

3. The method of claim 2, further comprising:
receiving, at the second processor, the second plurality of job descriptions from the second user,
transmitting, by the second processor, the second plurality of job descriptions and the second unique username to the server,
receiving, at the second processor, the second employment match from the server,
displaying, by the second processor, the second employment match to the second user,
receiving, at the second processor, a text message from the second user, and
transmitting, by the second processor, the text message to the first user based on the contact information included in the second employment match.

4. The method of claim 1, wherein the first employment match is character-limited.

5. The method of claim 1, wherein the first employment match is limited between approximately 140 characters and 200 characters.

6. The method of claim 1, further comprising, receiving, at the processor, at least one exact-match designation from the first user, the at least one exact-match designation indicating one of the first plurality of job descriptions as requiring an exact match.

7. The method of claim 1, wherein the contact information includes at least one of a telephone number, an email address, and a unique username.

8. The method of claim 1, wherein the first plurality of job descriptions includes a job title, job skills, a job location, a clearance level, and certifications.

9. The method of claim 1, wherein the second plurality of job descriptions includes a job title, job skills, a job location, a clearance level, and certifications.

10. The method of claim 1, wherein receiving the employment match includes receiving the employment match from the server as a text message.

11. A system for matching employers and candidates, the system comprising:
at least one processor configured to
receive a plurality of candidate profiles from a plurality of candidates, each of the plurality of candidate profiles including a unique username associated with one of the plurality of candidates and a plurality of job descriptions;
receive a plurality of employer profiles from a plurality of employers, each of the plurality of employer profiles including a unique username associated with one of the plurality of employers and a plurality of job descriptions;
determine a match between one of the plurality of candidates and one of the plurality of employers based on a degree of similarity between the plurality of job descriptions included in the one of the plurality of candidate profiles and the plurality of job descriptions included in the one of the plurality of employer profiles; and
provide information regarding the match to the one of the plurality of employers, the information including the unique username associated with the one of the plurality of candidates and no other identifying information of the one of the plurality of candidates.

12. The system of claim 11, wherein the at least one processor is further configured to provide second information regarding the match to the one of the plurality of candidates, the second information including the unique username associated with the one of the plurality of employers and no other identifying information of the one of the plurality of employers.

13. The system of claim 12, wherein the second information includes contact information for the one of the plurality of employers.

14. The system of claim 11, wherein the information includes contact information for the one of the plurality of candidates.

15. The system of claim 11, wherein the information is character-limited.

16. The system of claim 11, wherein the information is limited to between approximately 140 characters and approximately 200 characters.

17. The system of claim 11, wherein the information is a text message.

18. The system of claim 11, wherein the at least one processor is further configured to receive a message from the one of the plurality of candidates and transmit the message to the one of the plurality of employers.

19. The system of claim 11, wherein the at least one processor is further configured to receive a message from the one of the plurality of employers and transmit the message to the one of the plurality of candidates.

20. The system of claim 11, wherein the plurality of job descriptions included in each of the plurality of candidate profiles includes a job title, job skills, a job location, a clearance level, and certifications.

21. The system of claim 11, wherein the plurality of job descriptions included in each of the plurality of employer profiles includes a job title, job skills, a job location, a clearance level, and certifications.

22. The system of claim 11, wherein each of the plurality of candidate profiles further includes a designation for each of the plurality of job descriptions, each designation indicating whether the associated job description requires an exact match.

23. The system of claim 11, wherein each of the plurality of employer profiles further includes a designation for each of the plurality of job descriptions, each designation indicating whether the associated job description requires an exact match.

24. The system of claim 11, wherein the processor is configured to provide the information by adding the information to at least one of a feed and profile page.
